(19) United States
(12) Patent Application Publication
(10) Pub. No.: US 2015/0047332 A1
(43) Pub. Date: Feb. 19, 2015

(54) HYDROSTATIC ENERGY RECOVERY SYSTEM AND METHOD

(71) Applicant: BAE Systems Information and Electronic Systems Integration Inc., Nashua, NH (US)

(72) Inventors: John W. Luongo, Manchester, NH (US); Charles P. Wason, JR., Amherst, NH (US); Matthew M. DeAngelis, Bedford, NH (US)

(21) Appl. No.: 14/451,528

(22) Filed: Aug. 5, 2014

Related U.S. Application Data
(60) Provisional application No. 61/866,207, filed on Aug. 15, 2013.

(51) Int. Cl. F03B 17/02; F03B 11/00; F03B 13/10; F03G 7/04; F03B 15/02

(52) U.S. Cl. CPC F03B 17/02; F03G 7/04; F03B 15/02; F03B 13/10; F03B 11/004; F03B 11/008
USPC 60/327; 60/398

(57) ABSTRACT

A system and method for converting pressure differentials to electricity is disclosed. Initially, a first chamber is empty and a second chamber holds compressed air/fluid. When the device is disposed in the large bodies of water, due to pressure difference inside the first chamber and the ambient pressure, water fills the first chamber. As the water passes through the first chamber, it turns the turbine or creates pressure difference in transducer to produce electricity. The device descends itself in the deeper water column due to added water in first chamber. When the device obtains equilibrium, the compressed air/fluid from second chamber is allowed to flow to the first chamber to evacuate the filled water. The evacuating water again turns the turbine or creates pressure difference in transducer to produce electricity. After evacuation of water, the device will ascend itself to a shallower depth and the process repeats.

### CROSS-REFERENCE TO RELATED APPLICATIONS

This application claims rights under 35 USC §119(e) from U.S. Application Ser. No. 61/866,207 filed 15 Aug. 2013, the contents of which are incorporated herein by reference.

### TECHNICAL FIELD

The present disclosure relates generally to a hydrostatic energy recovery system. Embodiments of the disclosure are related to systems and methods of utilizing pressure differentials inherent in large bodies of water for harnessing energy in electrical form.

### BACKGROUND

Many underwater systems have been developed for generating renewable electrical energy from the water. Large bodies of water are deployed with the submerged energy generators that utilize the differential hydrostatic pressure prevailing between the peaks and the valleys of the sea waves. Such system converts the hydrostatic pressure variations such as generated by the off-shore sea waves, into useful energy.

Underwater systems have been built robustly to handle the rigors of service underwater. The system has to be designed considering the harsh environment including making sure that the increase in hydrostatic pressure due to increased depth does not hamper the system operations. Also, such system should be simple and should effectively manage the varying pressure without affecting the system operations.

A need, therefore, exists for an improved hydrostatic energy recovery system and method that overcomes the above drawbacks.

### SUMMARY

The following summary is provided to facilitate an understanding of some of the innovative features unique to the disclosed embodiment and is not intended to be a full description. A full appreciation of the various aspects of the embodiments disclosed herein can be gained by taking into consideration the entire specification, claims, drawings, and abstract as a whole.

It is, therefore, one aim of the disclosed embodiments to provide for a device for converting pressure differentials to electricity in large bodies of water. The device has a first chamber and a second chamber. The first chamber is fitted with a first valve and a turbine. The first chamber is disposed to fill or vent a first fluid due to pressure difference between the first chamber and the ambient pressure, through the first valve, such that the ingress or egress of the first fluid turns the turbine to produce an electrical charge. The second chamber is fitted with a second valve and configured to hold a second fluid in compressed form. The second valve allows the second fluid to transfer from the second chamber to the first chamber to create a pressure difference at deeper depth. A fluid compressor is configured to compress the second fluid into the second chamber and at least one electrical storage device is configured to receive the electrical charge from the turbine. A sensor is configured to detect pressure inside the first chamber and at least one controller is configured to operate the first valve and/or the second valve based on the pressure sensed by the sensor. The pressure exerted by the first fluid and/or the second fluid in the first chamber changes with location, such that the first chamber filed with first fluid descends the device in the water column and the first chamber filed with second fluid ascends the device in the water column.

It is, therefore, another aim of the disclosed embodiments to provide for a device for converting the pressure differentials to electricity in large bodies of water. The device has a first chamber and a second chamber. The first chamber is fitted with a first valve and a transducer. The first chamber is disposed to fill or vent a first fluid due to pressure difference between the first chamber and ambient pressure, through the first valve, such that the change in pressure in the first chamber exerts mechanical force on the transducer to produce a charge. The second chamber is fitted with a second valve and configured to hold a second fluid in compressed form. The second valve allows the second fluid to transfer from the second chamber to the first chamber to create a pressure difference at deeper depth. A fluid compressor configured to compress the second fluid into the second chamber and at least one electrical storage device configured to receive the charge from the transducer. Then, a sensor configured to detect pressure inside the first chamber and at least one controller configured to operate the first valve and/or the second valve based on the pressure detected by the sensor. The pressure exerted by the first fluid and/or the second fluid in the first chamber changes with location, such that the first chamber filed with first fluid descends the device in the water column and the first chamber filed with the second fluid ascends the device in the water column.

It is, therefore, one another aim of the disclosed embodiments to provide for a device for converting the pressure differentials to electricity in large bodies of water in which, the transducer is of a piezoelectric material and is compressed to generate electricity, when the pressure exerted by the first fluid changes with location.

It is, therefore, one another aim of the disclosed embodiments to provide for a device for converting the pressure differentials to electricity in large bodies of water in which, the first chamber filed with the first fluid descends the device in the water column until the device obtains equilibrium.

It is, therefore, yet another aim of the disclosed embodiments to provide for a device for converting the pressure differentials to electricity in large bodies of water in which, the first chamber filed with second fluid ascends the device in the water column until the device obtains equilibrium.

It is, therefore, one another aim of the disclosed embodiments to provide for a device for converting the pressure differentials to electricity in large bodies of water in which, the first fluid is the fluid surrounding the device in the water column.

It is, therefore, one another aim of the disclosed embodiments to provide for a device for converting the pressure differentials to electricity in large bodies of water in which, the second fluid creates the pressure difference in the first chamber, when the first chamber is fully filled with the first fluid and the device is in equilibrium after descending from shallower depth due to added weight of the first fluid.

It is, therefore, one another aim of the disclosed embodiments to provide for a device for converting the pressure differentials to electricity in large bodies of water in which, the first valve is configured to open at the shallower depth to fill the first chamber with the first fluid, when the first chamber is completely empty and the pressure sensed by the sensor is less than the ambient pressure.

It is, therefore, one another aim of the disclosed embodiments to provide for a device for converting the pressure differentials to electricity in large bodies of water in which, the first valve is configured to close at the shallower depth, when the first chamber is completely full and the pressure sensed by the sensor is equal to the ambient pressure.

It is, therefore, one another aim of the disclosed embodiments to provide for a device for converting the pressure differentials to electricity in large bodies of water in which, the first valve is configured to open at the deeper depth to vent the first fluid, when the first chamber is filled with first fluid and the device is in equilibrium after descending from shallower depth due to added weight of the first fluid.

It is, therefore, one another aim of the disclosed embodiments to provide for a device for converting the pressure differentials to electricity in large bodies of water in which, the first valve is configured to close at the deeper depth, when the first chamber is completely emptied with the first fluid and filled with the second fluid.

It is, therefore, one another aim of the disclosed embodiments to provide for a device for converting the pressure differentials to electricity in large bodies of water in which, the second valve at the deeper depth is configured to open when the first chamber is fully filled with first fluid and the device is in equilibrium after descending from shallower depth due to added weight of the first fluid and close when the first chamber is completely vented and filled with the second compressed fluid.

It is, therefore, another aim of the disclosed embodiments to provide for a device for converting the pressure differentials to electricity in large bodies of water in which, the second valve at the shallower depth is configured to be closed always.

It is, therefore, one another aim of the disclosed embodiments to provide for a method for converting the pressure differentials to electricity in large bodies of water comprising moving a transducer through a fluid, wherein the pressure exerted by the fluid changes with location and capturing electrical energy manufactured by the transducer in an electrical storage device.

It is, therefore, one another aim of the disclosed embodiments to provide for a method for converting the pressure differentials to electricity in large bodies of water comprising providing a first chamber with a first valve and a turbine, wherein the first chamber is initially empty, providing a second chamber with a second valve, wherein the second chamber is filled with a second fluid that is in compressed form, providing the first and second chambers in the large bodies of water, filling the first chamber with a first fluid by opening the first valve due to pressure difference between the first chamber and the ambient, turning the turbine at the time of filling the first chamber, converting mechanical energy of the turbine to the electrical energy and storing the electrical energy. The method further comprises closing the first valve after filling the first fluid, allowing the first and second chambers to descend itself into the deeper depth due to added weight of the first chamber until the equilibrium is reached, opening the second valve and allowing the second compressed fluid to pass from the second chamber to the first chamber until the first chamber is completely vented with the first fluid, turning the turbine at the time of venting the first chamber, converting mechanical energy of the turbine to the electrical energy and storing the electrical energy, closing the first valve and the second valve after venting the first fluid and allowing the first and second chambers to ascend itself into the deeper depth due to lesser weight of the first chamber until the equilibrium is reached.

It is, therefore, one another aim of the disclosed embodiments to provide for a method for converting the pressure differentials to electricity in large bodies of water comprising providing a first chamber with a first valve and a transducer, wherein the first chamber is initially empty, providing a second chamber with a second valve, wherein the second chamber is filled with a second fluid that is in compressed form, providing the first and second chambers in the large bodies of water, filling the first chamber with a first fluid by opening the first valve due to pressure difference between the first chamber and the ambient, utilizing the transducer to convert the pressure difference into electrical energy, wherein the change in the pressure in the first chamber exerts mechanical force on the transducer to create electrical energy and storing the electrical energy. The method further comprises closing the first valve after filling the first fluid, allowing the first and second chambers to descend itself into the deeper depth due to added weight of the first chamber until the equilibrium is reached, opening the second valve and allowing the second compressed fluid to pass from the second chamber to the first chamber until the first chamber is completely vented with the first fluid, utilizing the transducer to convert the pressure difference into electrical energy, wherein the change in the pressure in the first chamber exerts mechanical force on the transducer to create electrical energy, storing the electrical energy, closing the first valve and the second valve after venting the first fluid and allowing the first and second chambers to ascend itself into the deeper depth due to lesser weight of the first chamber until the equilibrium is reached.

It is, therefore, one another aim of the disclosed embodiments to provide for a method or device for converting the pressure differentials to electricity in large bodies of water in which, the second chamber is configured to a compressed air or fluid.

It is, therefore, one another aim of the disclosed embodiments to provide for a method for converting the pressure differentials to electricity in large bodies of water in which, the first chamber filled with the first fluid at shallower depth moves the first and second chamber from shallower to deeper depth and the first chamber filled with the second fluid at deeper depth moves the first and second chamber from deeper to shallower depth.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

FIG. 1A is an illustration of a side view of a device for capturing energy through a turbine utilizing pressure changes in fluids as depth increases in large bodies of water, in accordance with the disclosed embodiments;

FIG. 1B is an illustration of a side view of a device for capturing energy through a transducer utilizing pressure changes in fluids as depth increases in large bodies of water, in accordance with the alternate embodiments;

FIG. 2 is an illustration of a simple flowchart showing a process for converting pressure to energy utilizing the device depicted in FIG. 1A or FIG. 1B, in accordance with the disclosed embodiments;

FIG. 3 is an illustration of a flowchart showing setup process for converting pressure to energy utilizing the device depicted in FIG. 1A or FIG. 18, in accordance with the disclosed embodiments;

FIGS. 4A-4B is an illustration of a flowchart showing a process for converting pressure to energy utilizing the device depicted in FIG. 1A, in accordance with the disclosed embodiments; and

FIGS. 5A-5B is an illustration of a flowchart showing a process for converting pressure to energy utilizing the device depicted in FIG. 1B, in accordance with the disclosed embodiments.

### DETAILED DESCRIPTION OF ILLUSTRATIVE EMBODIMENTS

The particular configurations discussed in the following description are non-limiting examples that can be varied and are cited merely to illustrate at least one embodiment and are not intended to limit the scope thereof.

A system and method for converting pressure differentials to electricity is disclosed. Initially, a first chamber is empty and a second chamber holds compressed air/fluid. When the device is disposed in the large bodies of water, due to pressure difference inside the first chamber and the ambient pressure, water fills the first chamber. As the water passes through the first chamber, it turns the turbine or creates pressure difference in transducer to produce electricity. The device descends itself in the deeper water column due to added water in first chamber. When the device obtains equilibrium, the compressed air/fluid from second chamber is allowed to flow to the first chamber to evacuate the filled water. The evacuating water again turns the turbine or creates pressure difference in transducer to produce electricity. After evacuation of water, the device will ascend itself to a shallower depth and the process repeats.

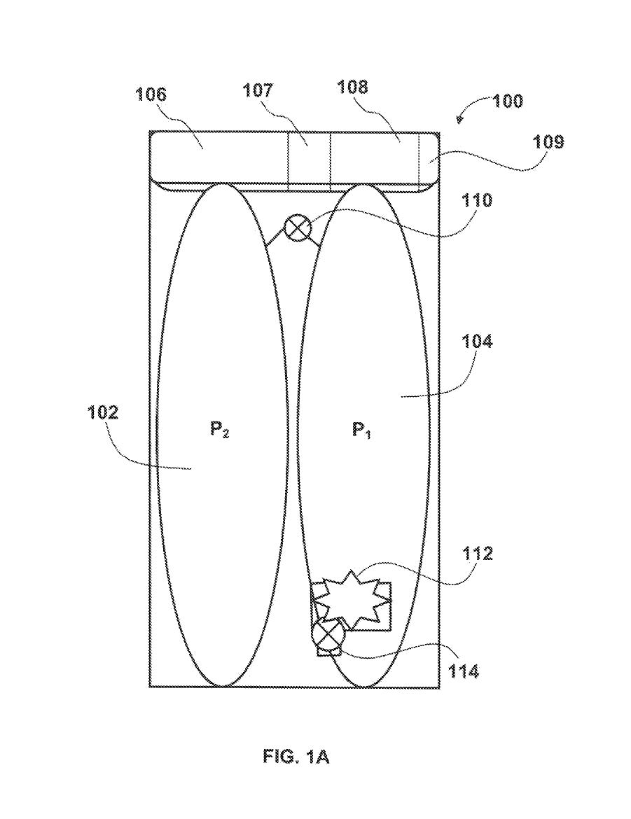

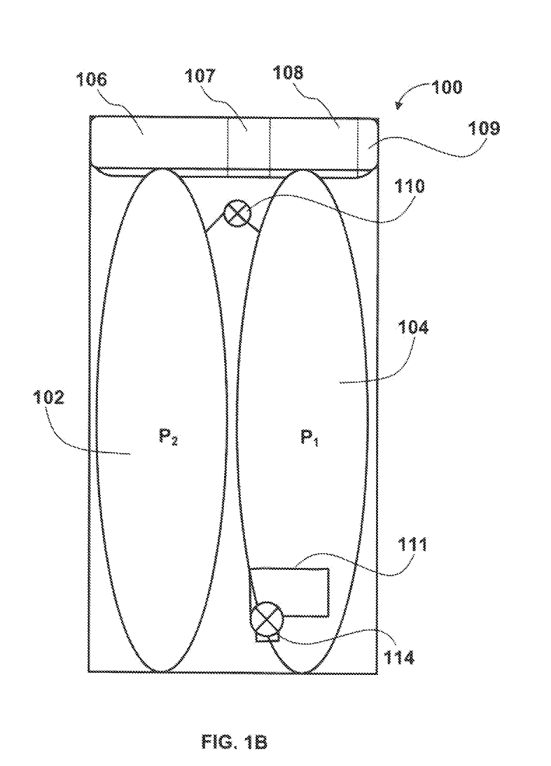

Referring to FIG. 1A, an illustration of a side view of a device 100 for capturing energy through a turbine 112 utilizing pressure changes in fluids as depth increases in a large bodies of water is disclosed. The device 100 has a first chamber 104, a second chamber 102, a sensor 106, an air compressor 107, an electrical storage device 108 and a controller 109. The first chamber 104 is fitted with a first valve 114 and a turbine 112. The first chamber 104 is disposed to fill or vent a first fluid due to pressure difference between the first chamber 104 and the ambient pressure, through the first valve 114, such that the ingress or egress of the first fluid turns the turbine 112 to produce an electrical charge. The second chamber 102 is fitted with a second valve 110 and configured to hold a second fluid in compressed form. The second valve 110 allows the second fluid to transfer from the second chamber 102 to the first chamber 104 to create a pressure difference at a deeper depth.

The fluid compressor 107 is utilized to compress the second fluid into the second chamber 102 and the electrical storage device 108 is configured to receive the electrical charge from the turbine 112. The sensor 106 detects the pressure inside the first chamber 104 and the controller 109 is configured to operate the first valve 114 and/or the second valve 110 based on the pressure sensed by the sensor 106. The pressure exerted by the first fluid and/or the second fluid in the first chamber 104 changes with location, such that the first chamber 104 filed with first fluid descends the device 100 in the water column and the first chamber 104 filed with second fluid ascends the device 100 in the water column.

FIG. 1B illustrates the device 100 depicted in FIG. 1A utilizing a transducer 111 instead of the turbine 112 for generating the electrical energy. The transducer 111 is a piezoelectric transducer that generates piezoelectricity. In general, piezoelectricity is the electricity produced by mechanical pressure on certain crystals, notably quartz or Rochelle salt. The electrostatic stress on such crystal produces a change in the linear dimensions of the crystal and hence produces the piezoelectricity. The pressure difference between first chamber 104 and the ambient pressure compresses the transducer 111 and produce the electrical charges. The generated electrical charges are stored in the electrical storage device 108.

It should be noted that the pressure inside the first chamber 104 is varied in varying depth of the device 100 in the water column. The sensor 108 senses varying pressure in the first chamber 104 and send the pressure information to the controller 109. The controller 109 controls the first and the second valves 114 and 110 based on the pressure information.

When the device 100 is at the shallower depth, the sensor 106 detects the pressure in the first chamber 104 and sends the pressure information to the controller 109 at predetermined intervals. The controller 109 opens the first valve 114 and keeps the first valve opened until the pressure in the first chamber 104 is less than the ambient pressure. The controller 109 closes the first valve 114 when the pressure in the first chamber 104 and the ambient pressure are equal. It should be noted that when the first valve 114 is opened, the water surrounding the device 100 fills the first chamber 104. The device 100 descends itself from shallower depth to the deeper depth, due to added weight of the first fluid in the first chamber 104, until the device 100 attain equilibrium in the water column at the deeper depth.

When the device 100 is in equilibrium at the deeper depth, the controller 109 opens the first valve 114 and the second valve 110. The first valve 114 vents the water inside the first chamber 104 and second valve 112 allows the second fluid to pass from the second chamber 102 to the first chamber 104, until all the water inside the first chamber 104 is vented. The controller 109 closes the first valve 114 and the second valve 110 when the first chamber 104 is completely vented with first fluid and filled with the second fluid. It should be noted that change in the pressure in the first chamber 104 at shallower and deeper depth compresses the transducer 111 and thus generates electrical energy.

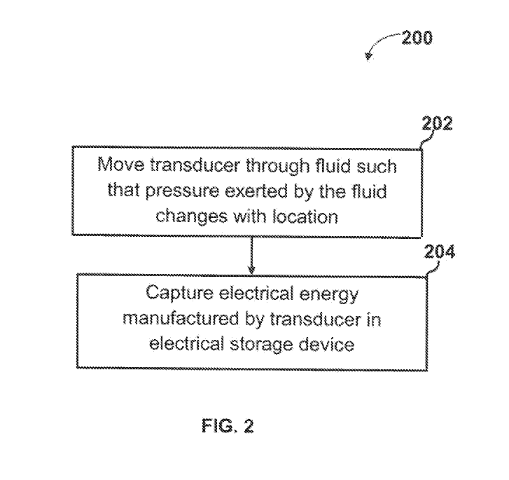

FIG. 2 illustrates a simple flow chart pertaining a method 200 of converting pressure to electrical energy, utilizing the device 100 depicted in FIG. 1A or FIG. 1B. As said at block 202, the varying pressure in a chamber, fills or vents the chamber with a fluid and hence moves a transducer or rotates the turbine. The pressure exerted by the fluid changes with location. The transducer can be the transducer 111 depicted in FIG. 1B and the turbine can be the turbine 112 depicted in FIG. 1A. Then, as illustrated at block 204, the compressed transducer or the turning turbine, generates electrical energy and generated electrical energy is stored in an electrical storage device. Thus, the moving fluid or the varying pressure generates electrical energy.

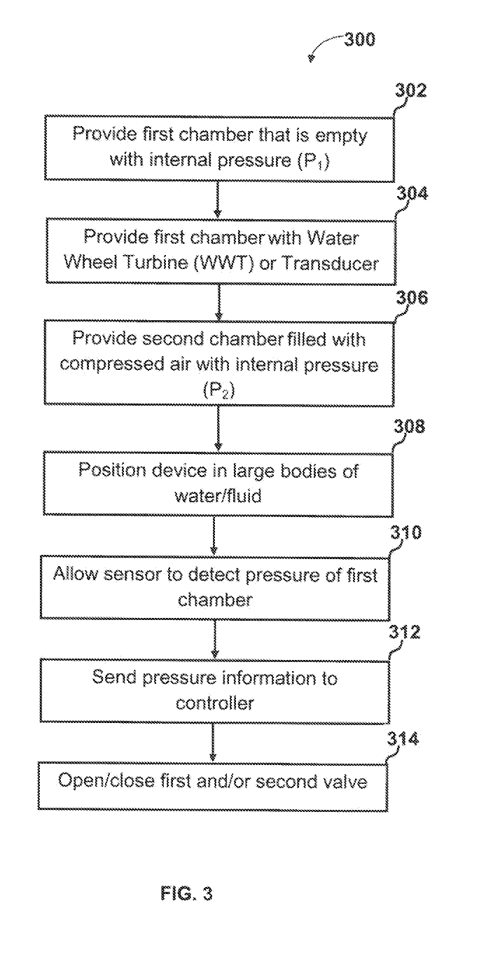

FIG. 3 is an illustration of a flowchart showing a setup process 300 for converting pressure to electrical energy, utilizing the device 100 depicted in FIG. 1A or FIG. 1B, in accordance with the disclosed embodiments. As said at the block 302 and 306 initially, a first chamber is empty with internal pressure (P₁) and the second chamber is filled with compressed air with internal pressure (P₂). The first chamber is fitted with a Water Wheel Turbine (WWT) or Transducer, as depicted at block 304. The transducer can be the transducer 111 depicted in FIG. 18 and the turbine can be the turbine 112 depicted in FIG. 1A. As illustrates at block 308, the device 100 is positioned in a large bodies of water/fluid such that first chamber receive water/fluid surrounding it. The sensor detects the pressure of the first chamber and sends the pressure information to the controller as said at block 310 and 312. Then, as said at block 314, the controller opens or closes the first valve and/or second valve, when there is a pressure difference between the first chamber and the ambient pressure. It should be noted that the setup process 300 is same for the transducer or the turbine depicted in FIG. 1A and FIG. 1B.

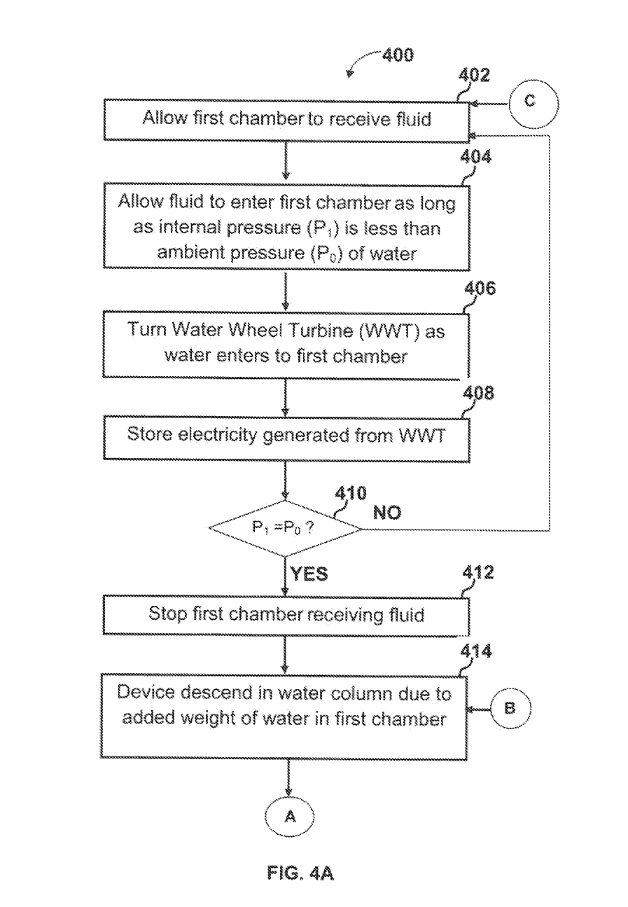

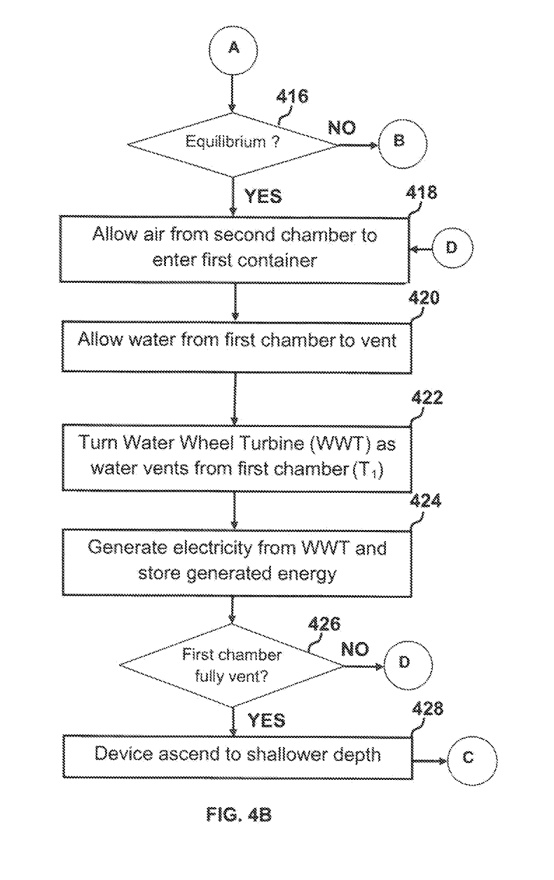

FIGS. 4A-4B is an illustration of a flowchart showing a process 400 for converting pressure to electrical energy utilizing the device depicted in FIG. 1A, in accordance with the disclosed embodiments. After the setup process 300, as depicted in FIG. 3, initially, the controller opens the first valve, as the pressure of the first chamber is less than the ambient pressure. As said at block 402, the first chamber receives water that is surrounding the device, when the first valve is opened. The water fills the first chamber as long as the internal pressure (P₁) of the first chamber is equal to the ambient pressure (P₀) of the water, as depicted at block 404. As said at the block 406, the entering water in the first chamber turns the turbine fitted to the first valve. The rotating turbine generates electricity and the generated electric energy is stored in an electrical storage device, as illustrated at the block 408. The controller closes the first valve, when the internal pressure of the first chamber is equal to the ambient pressure, as said at the block 410 and 412.

As depicted at block 414, the added weight of the water in the first chamber descends the device in the water column from the shallower depth to the deeper depth, until the device achieves equilibrium in the water column. Once the device achieves equilibrium, to once again rotate the turbine, as said at blocks 416, 418 and 420, the controller opens the first and the second valves, such that the compressed air in the second chamber enters the first chamber through the second valve and the water in the first chamber vents through the first valve. At block 422 and 424, the venting water once again rotates the turbine and generates the electrical energy that is stored in the electrical storage device. The device ascends to the shallower depth, when the first chamber is completely vented and filled with the second fluid, as said at the blocks 426 and 428. After ascending, the device once again performs the process 400.

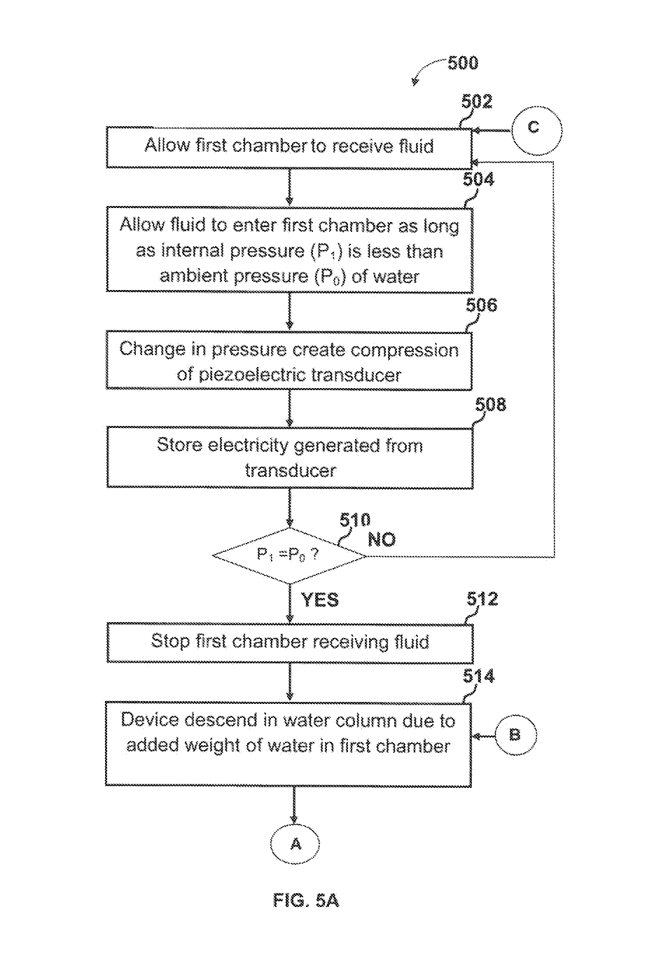

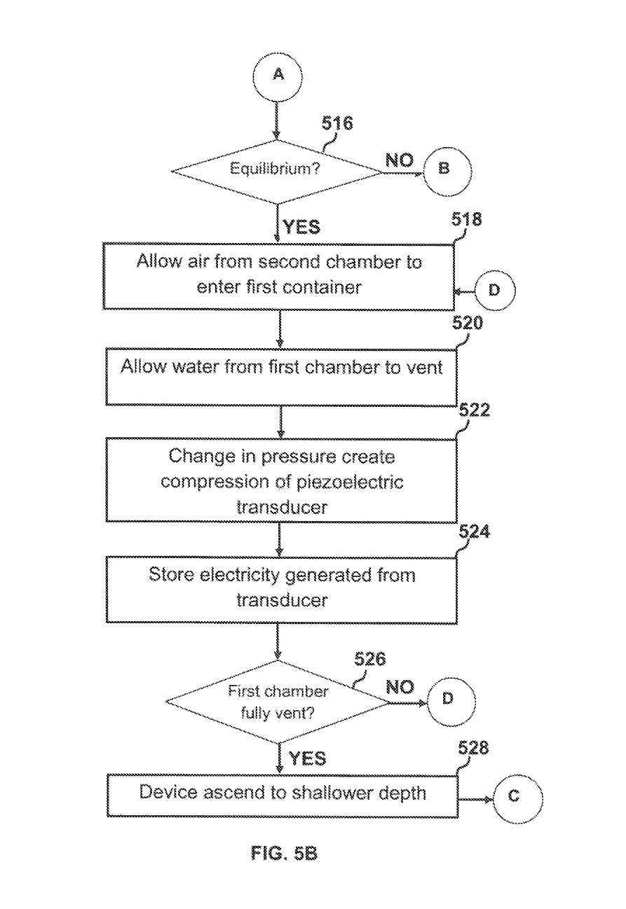

FIGS. 5A-5B is an illustration of a flowchart showing a process 500 for converting the pressure to electrical energy, utilizing the device depicted in FIG. 1B, in accordance with the disclosed embodiments. After the setup process 300, as depicted in FIG. 3, initially the controller opens the first valve as the pressure of the first chamber (P₁) is less than the ambient pressure (P₀). As said at block 502, the first chamber receives the water that is surrounding the device, when the first valve is opened. The water fills the first chamber as long as the internal pressure (P₁) of the first chamber is equal to the ambient pressure (P₀) of the water, as depicted at block 504. As said at the block 506, the change in the pressure creates compression in the piezoelectric transducer. The compression in the piezoelectric transducer generates electricity and the generated electric energy is stored in an electrical storage device, as illustrated at the block 508. The controller closes the first valve, when the internal pressure of the first chamber is equal to the ambient pressure, as said at the blocks 510 and 512.

As depicted at the block 514, the added weight of the water in the first chamber descends the device in the water column from the shallower depth to the deeper depth, until the device achieves equilibrium in the water column. Once the device achieves equilibrium, to once again generate electrical energy, as said at blocks 516, 518 and 520, the controller opens the first and the second valves, such that the compressed air in the second chamber enters the first chamber through the second valve and the water in the first chamber vents through the first valve. At block 522 and 524, the change in the pressure once again creates compression in the piezoelectric transducer and hence generates the electrical energy that is stored in the electrical storage device. The device ascends to the shallower depth, when the first chamber is completely vented and filled with the second fluid, as said at the blocks 526 and 528. After ascending, the device once again performs the process 500.

It should be noted that the first valve is configured to open at the deeper depth when the first chamber is filled with the first fluid and the device is in equilibrium after descending from the shallower depth due to added weight of the first fluid and the first valve is configured to close at the deeper depth when the first chamber is completely empty. Further, the second valve at the deeper depth is configured to open when the first chamber is fully filled with first fluid and the device is in equilibrium after descending from shallower depth due to added weight of the first fluid and close when the first chamber is completely vented and filled with the second compressed fluid.

It should also be noted that the above embodiments, the device is placed in the large bodies of water and hence surrounded by the water, but the device can be placed in any larger fluid area of deeper depth to obtain the teachings of the invention. Further, the embodiments are not limited to the use of compressed air in the second fluid but can also hold compressed fluid. Also, the controller is configured to open or close the valves suitably, in order to achieve the required pressure difference in the first chamber with respect to ambient pressure, for continuous generation of electrical energy. Thus, the increase in hydrostatic pressure due to increased depth does not hamper device operations.

It will be appreciated that variations of the above disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

Although embodiments of the current disclosure have been described comprehensively in considerable detail to cover the possible aspects, those skilled in the art would recognize that other versions of the disclosure are also possible.

What is claimed is:

1. A device for converting pressure differentials to electricity in large bodies of water, comprising:
a first chamber fitted with a first valve and a turbine, wherein the first chamber is disposed to fill or vent a first fluid due to a pressure difference between the first chamber and an ambient, through the first valve, such that the ingress or egress of the first fluid turns the turbine to produce a charge;
a second chamber fitted with a second valve and configured to hold a second fluid in compressed form, wherein the second valve allows the second fluid to transfer from the second chamber to the first chamber to create a pressure difference at a deeper depth;
a fluid compressor configured to compress the second fluid into the second chamber;
at least one electrical storage device configured to receive the charge from the turbine,
a sensor configured to detect a pressure inside the first chamber; and
at least one controller configured to operate first valve and/or second valve based on the pressure sensed by the sensor,
wherein the pressure exerted by the first fluid and/or second fluid in the first chamber changes with location such that the first chamber filed with the first fluid descends the device in a water column and the first chamber filed with second fluid ascends the device in the water column.

2. A device for converting pressure differentials to electricity in large bodies of water, comprising:
a first chamber fitted with a first valve and a transducer, wherein the first chamber is disposed to fill or vent a first fluid due to a pressure difference between the first chamber and an ambient, through the first valve, such that the change in pressure in the first chamber exerts a mechanical force on the transducer to produce a charge;
a second chamber fitted with a second valve and configured to hold a second fluid in compressed form, wherein the second valve allows the second fluid to transfer from the second chamber to the first chamber to create the pressure difference at a deeper depth;
a fluid compressor configured to compress the second fluid into the second chamber;
at least one electrical storage device configured to receive the charge from the transducer;
a sensor configured to detect a pressure inside the first chamber; and
at least one controller configured to operate the first valve and/or the second valve based on the pressure detected by the sensor,
wherein the first chamber filed with the first fluid descends the device in a water column and the first chamber filed with second fluid ascends the device in the water column.

3. The device of claim 2 wherein the transducer comprises a piezoelectric material and is compressed to generate electricity when the pressure exerted by the first fluid changes with location.

4. The device of claim 1 wherein the first chamber filed with the first fluid descends the device in the water column until the device obtains equilibrium.

5. The device of claim 1 wherein the first chamber filed with second fluid ascends the device in the water column until the device obtains equilibrium.

6. The device of claim 1 wherein the first fluid is the fluid surrounding the device in the water column.

7. The device of claim 1 wherein the second fluid creates the pressure difference in the first chamber when the first chamber is fully filled with first fluid and the device is in equilibrium after descending from a shallower depth due to added weight of the first fluid.

8. The device of claim 1 wherein the first valve is configured to open at the shallower depth to fill the first chamber with the first fluid when:
the first chamber is completely empty; and
the pressure sensed by the sensor is less than the ambient pressure.

9. The device of claim 1 wherein the first valve is configured to close at the shallower depth when:
the first chamber is completely filled with the first fluid; and
the pressure sensed by the sensor is equal to the ambient pressure.

10. The device of claim 1 wherein the first valve is configured to open at the deeper depth to vent the first chamber when the first chamber is filled with the first fluid and the device is in equilibrium after descending from the shallower depth due to added weight of the first fluid.

11. The device of claim 1 wherein the first valve is configured to close at the deeper depth when the first chamber is completely emptied with the first fluid and filled with the second fluid

12. The device of claim 1 wherein the second valve at the deeper depth is configured to:
open to fill the second fluid from the second chamber to the first chamber when the first chamber is fully filled with first fluid and the device is in equilibrium after descending from the shallower depth due to added weight of the first fluid; and
close when the first chamber is completely vented with the first fluid and filled with the second fluid.

13. The device of claim 1 wherein the second valve at the shallower depth is configured to be closed always.

14. The device of claim 1 wherein the second chamber is configured to hold a compressed air.

15. A method for converting pressure to energy comprising:
moving a transducer through a fluid, wherein the pressure exerted by the fluid changes with location; and
capturing electrical energy manufactured by the transducer in an electrical storage device.

16. A method for converting pressure to energy in large bodies of water, comprising:
providing a first chamber with a first valve and a turbine, wherein the first chamber is initially empty;
providing a second chamber with a second valve, wherein the second chamber is filled with a second fluid that is in compressed form;
providing the first and second chambers in the large bodies of water;
filling the first chamber with a first fluid by opening the first valve due to a pressure difference between the first chamber and the ambient;
turning the turbine at the time of filling the first chamber;
converting a rotational energy of the turbine to an electrical energy and storing the electrical energy;
closing the first valve after filling the first fluid;
allowing the first and second chambers to descend itself into a deeper depth due to added weight of the first chamber until the equilibrium is reached;
opening the first and second valves and allowing the second fluid to pass from the second chamber to fill the first chamber until the first chamber is completely vented with the first fluid;
turning the turbine at the time of venting the first chamber;
converting the rotational energy of the turbine to the electrical energy and storing the electrical energy;
closing the first and second valves after venting the first fluid; and
allowing the first and second chambers to ascend itself into the deeper depth due to lesser weight of the first chamber until the equilibrium is reached.

17. A method for converting pressure to energy in large bodies of water, comprising:
providing a first chamber with a first valve and a transducer, wherein the first chamber is initially empty;
providing a second chamber with a second valve, wherein the second chamber is filled with a second fluid that is in compressed form;
providing the first and second chambers in the large bodies of water;
filling the first chamber with a first fluid by opening the first valve due to a pressure difference between the first chamber and the ambient;
utilizing the transducer to convert the pressure difference into an electrical energy, wherein the change in the pressure in the first chamber exerts a mechanical force on the transducer to create the electrical energy;
storing the electrical energy;
closing the first valve after filling the first fluid;
allowing the first and second chambers to descend itself into the deeper depth due to added weight of the first chamber until the equilibrium is reached;
opening the first and second valves and allowing the second compressed fluid to pass from the second chamber to the first chamber until the first chamber is completely vented with the first fluid;
utilizing the transducer to convert the pressure difference into electrical energy, wherein the change in the pressure in the first chamber exerts mechanical force on the transducer to create electrical energy;
storing the electrical energy;
closing the first and second valve after venting the first fluid; and
allowing the first and second chambers to ascend itself into the deeper depth due to lesser weight of the first chamber until the equilibrium is reached.

18. The method of claim 16 wherein the second chamber is configured to hold a compressed air.

19. The method claim 16 wherein the first chamber filled with the first fluid at shallower depth moves the first and second chamber from shallower to deeper depth.

20. The method of claim 16 wherein the first chamber filled with the second fluid at deeper depth moves the first and second chamber from deeper to shallower depth.

21. The method of claim 18 wherein the second chamber is configured to hold a compressed air.

22. The method of claim 18 wherein the first chamber filled with the first fluid at shallower depth moves the first and second chamber from shallower to deeper depth.

23. The method of claim 18 wherein the first chamber filled with the second fluid at deeper depth moves the first and second chamber from deeper to shallower depth.
